(19) United States
(12) Patent Application Publication
(10) Pub. No.: US 2012/0223485 A1
(43) Pub. Date: Sep. 6, 2012

(54) LINK SEAL FOR TRACK OF TRACKED VEHICLES

(76) Inventor: JEONG-JUNG HEO, Busan (KR)

(21) Appl. No.: 13/040,572

(22) Filed: Mar. 4, 2011

(51) Int. Cl. F16J 15/16

(52) U.S. Cl. 277/500

(57) ABSTRACT

The present invention relates to a link seal for a track of a tracked vehicle, in which fine protrusions of an indefinite pattern are formed on the adhesive surface of the seating groove of the main body made of a high-strength resin and the adhesive surface of the seating part of the sub-body made of an urethane resin and then the adhesive surfaces of the seating groove and the seating part are treated roughly into surfaces of a fine concavo-convex shape to increase the adhesion between the main body and sub-body. The link seal includes: an annular main body including a seating groove, a circumferential flange portion, and an annular sleeve; an annular sub-body including a seating part; and an annular rubber ring made of a cushion material and having a through-hole 301 formed at the center thereof.

### BACKGROUND OF THE INVENTION

1. Field of the Invention

Exemplary embodiments of the present invention relate to a link seal for a track of a tracked vehicle, and more particularly, to such a link seal for a track of a tracked vehicle, in which fine protrusions of an indefinite pattern are formed on the seating groove of the main body made of a high-strength resin and the seating part of the sub-body made of an urethane resin and then the surfaces of the seating groove and the seating part are treated roughly to increase the adhesion between the main body and sub-body, and in which first protuberances and second protuberances of a cylindrical or conical shape are formed on the seating groove and a circumferential flange portion of the main body at regular intervals, respectively, to improve the adhesion between the main body and the sub-body and the engagement force between the main body and the cushioning rubber ring so that parts of the link seal are prevented from being disengaged from each other even by a high frictional heat generated from a shaft of the track or an external force of a high load in case of the use of the link seal for a long period of time, thereby improving durability of the link seal.

2. Background of the Related Art

In general, heavy equipments such as dozers, cranes, excavators, and the like, tanks, and combat weapons such as self-propelled guns, armored personnel carriers, and the like are mostly tracked vehicles, which are driven by a driving device equipped with a caterpillar track.

Such a tracked vehicle includes an upper track mounted at a top of a side frame to prevent the track from being sagged, and a lower track mounted at a lower portion thereof to evenly distribute the weight of the equipment to the ground surface through the large surface area of the track to smoothly drive the tracked vehicle. Mounted axially on the track is a seal having the shape of an O-ring so that the seal can be rotated, and simultaneously can function to prevent leakage of oil injected into a track shaft.

Such a convention seal, as shown in FIG. 1, is injection-molded of a urethane resin to form a certain annular shape. An annular reinforcing metal core 3, which was previously fabricated as shown in FIG. 2, is positioned at the inside of the molded urethane resin body 4.

The annular reinforcing metal core 3 serving as a support is manufactured by a press machining technique, and then is placed in a mold (not shown). Then, when a urethane resin is injected in the mold to be molded into a given shape, the annular reinforcing metal core 3 and the urethane resin body 4 are formed integrally with each other to thereby form a seal 2.

In other words, in order to integrally form the annular reinforcing metal core 3 with the urethane resin body 4 using the annular reinforcing metal core 3, a number of holes 4a are formed on the top circumferential end surface of the injection-molded urethane resin body 4 and a number of vertical grooves 4b are formed on the inner circumferential surface of the injection-molded urethane resin body 4 at regular intervals so that the annular reinforcing metal core 3 is correctly positioned at the inside of the molded urethane resin body 4. However, these holes and vertical grooves are prone to be abraded away when the seal is mounted axially on the track and then is used for a long period time. There may occur a problem in that the abraded holes 4a and vertical grooves 4b cause oil to be leaked to the outside or foreign substances such as moisture or dust particles to easily infiltrate into the seal.

Thus, the conventionally embodied seal 2 entails a problem in that since it employs the annular reinforcing metal core 3 serving as a support when in use for a long period of time, so that once crushed or deformed by a large force or pressure, it does not return immediately to its original shape, which makes it impossible to function as an O-ring. In addition, when the seal rusts to be corroded, its shape itself is expanded, which makes it impossible to perform a tight sealing function to cause leakage of oil. Alternatively, when foreign substances infiltrate into the seal, a smooth rotation drive of the tracked vehicles is not carried out. Further, when foreign substances such as moisture or dust particles infiltrate into the seal, a shaft of the track rotatably driving the track is corroded and deterioration of oil due to infiltration of moisture is accelerated, leading to a damage of expensive heavy equipments or tracked vehicles or a reduction in the endurance lifespan.

Therefore, in an effort to solve the above-mentioned problems, the present inventor has developed an O-ring shaped link seal 100 including a first O-ring 10 and a second O-ring 20, which are configured to be engaged with and easily disengaged from each other as shown in FIGS. 3 and 4. Such a link seal 100 as constructed above has been registered as Korean Patent Registration No. 0656153, in which two different members are integrally formed with each other to constitute the first O-ring 10 in such a fashion that a seal body 10a made of a high-strength resin is disposed at a portion to which a large pressure is applied so that the seal body 10a can serve as a support capable of enduring the large pressure and a sealing part 10b made of an urethane resin is disposed at a portion to which a smaller pressure is applied because different pressures are applied to two portions by rotation of a track shaft of the tracked vehicle.

The link seal 100 as constructed above is mounted on the track shaft of the tracked vehicle is mounted on the track shaft of the tracked vehicle, and thus has an effect of preventing leakage of oil injected into the tracked shaft and at the same time preventing infiltration and introduction of foreign substances such as moisture or dust particles generated from the outside into the track shaft. However, the link seal 100 encounters problems in that the link seal 100 and a bushing abutting against the outer circumference of the link seal 100 are brought into close contact with each other while a certain force is exerted therebetween by the rotation of the bushing to create a high load exceeding a given value and a frictional heat. In addition, if an external high load and a frictional heat are transmitted to the link seal 100 for a certain period of time, the sealing part 10b acting as a sub-body constituting a link seal assembly is abraded away, and resultantly the sub-body 10b may be separated from the main body 10a or broken, which leads to having an influence on the driving power and the endurance lifespan of the expensive equipment.

In an effort to solve the above-mentioned problems, the present inventor has developed a link seal which includes an annular main body 100, an annular sub-body 200 provided on one side of the main body 100, a rubber ring 390 made of a cushion material as shown in FIG. 5. The link seal has a structure in which the main body 100, the sub-body 200, and the rubber ring 390 are assembled with each other as shown in FIG. 4. The main body 100 has a plurality of radially spaced rows of annular protrusion lines 310 formed along a seating groove 120 thereof so that the sub-body 200 is engaged with the seating groove 120. The sub-body 200 has a plurality of radially spaced rows of annular grooves (not shown) formed on a bottom surface thereof so as to allow the annular protrusion lines 310 of the main body 100 to be fitted thereto. In addition, the present inventor has developed a link seal that includes an annular main body 100 having two radially spaced rows of annular fitting recesses 320′ formed circumferentially on an end surface thereof in such a fashion that a pair of opposing fitting recesses of two rows are arranged symmetrically and form an acute angle (θ) therebetween, an annular sub-body 200 provided on one side of the main body and having two radially spaced rows of annular fitting protrusions formed on a bottom surface thereof to correspond to the fitting recesses 320′ in such a fashion that a pair of opposing fitting protrusions of two rows are arranged symmetrically and form an acute angle therebetween so as to allow the fitting protrusions to be fitted into the fitting recesses 320′ of the main body 100, and a rubber ring 390 as shown in FIG. 6. Then, the developed link seal has been registered as Korean Patent Registration No. 0856458. Such a link seal, however, still involves a problem in that the link seal mounted on the track shaft of a tracked vehicle can be separated from the track shaft or is damaged under the worst conditions like the above-mentioned problems.

Moreover, there has been a problem in that a slip or spin phenomenon occurs between the seal body and the cushion member formed of the rubber ring, which constitute the link seal assembly. That is, the rubber ring engaged with the outer surface of a sleeve of the main body undergoes a resistance by a repulsive elastic force of the rubber ring itself and a rotation frictional force caused by an external high load of the bushing after the lapse of a certain period or time. In addition, an oil film is formed between the main body and the rubber ring serving as the cushion member. Thus, the rubber ring serving as the cushion member is separated from the seal body to cause the rubber ring to be rotated, which leads to a spin or slip phenomenon.

Such a slip phenomenon enables heat to be generated from a contact surface between the two different members by friction, so that deterioration of the seal body and excessive abrasion of the rubber ring serving as the cushion member occur, and ultimately an intrinsic function of the link seal is lost and even a lifespan of the expensive equipment is affected by the slip phenomenon.

In the meantime, in an effort to solve the above-mentioned problems, there has been developed a link seal having a structured as shown in FIG. 7 in a caterpillar. The link seal includes splines 84 of various shapes formed along the outer circumference of a texture surface thereof as shown in FIGS. 8 and 9 so that a slip or spin phenomenon is prevented from occurring on a contact surface between a seal body and a rubber ring (i.e., load ring) to improve durability of the link seal. Then, the link seal has been registered as a statutory invention registration publication No. H1180 in United States Patent Trademark Office (USPTO).

Such a conventional link seal, however, still encounters a problem in that the link seal is separated from the track shaft of a tracked vehicle under the worst conditions even in the case where a link seal includes various shapes of profiles 85a and 85′ formed on the outer surface of a sleeve as shown in FIGS. 8 and 9 instead of the splines 84.

### SUMMARY OF THE INVENTION

Accordingly, the present invention has been made in order to solve the above-described problems occurring in the prior art, and it is an object of the present invention to provide a link seal for a track of a tracked vehicle, in which fine protrusions of an indefinite pattern are formed on the adhesive surface of the seating groove of the main body made of a high-strength resin and the adhesive surface of the seating part of the sub-body made of an urethane resin and then the adhesive surfaces of the seating groove and the seating part are treated roughly into surfaces of a fine concavo-convex shape to increase the adhesion between the main body and sub-body.

Another object of the present invention is to provide a link seal for a track of a tracked vehicle, in which first protuberances of a cylindrical or conical shape are formed on the seating groove the main body at regular intervals so that the protuberances presses the adhesive surface of the sub-body upon the integral engagement between the main body and the sub-body, thereby maximizing the cohesion between two different members, and in which the first protuberance of a cylindrical or conical shape serves as a support which supports the sub-body (sealing part), so that the main body and the sub-body are not easily disengaged from each other or damaged and can stably maintain an intrinsic function of the link seal even under the external bad conditions such as a high load, a rotation frictional force, etc., by the rotation driving of the tracked vehicle having a caterpillar.

Still another object of the present invention is to provide a link seal for a track of a tracked vehicle, in which concavo-convex serrations are formed on the outer peripheral surface of the sleeve extending from the bottom surface of the annular main body to press the inner peripheral surface of the rubber ring, and cylindrical or conical shaped second protuberances are circumferentially formed at regular intervals on the circumferential flange portion of the sleeve to securely press the top surface of the cushioning rubber ring so that a slip or spin phenomenon can be prevented from occurring on the adhesive surfaces between the seal body and cushioning rubber ring of the link seal during the operation of the track, thereby further improving the engagement force between the seal body and cushioning rubber ring.

Thus, the link seal for a track of a tracked vehicle according to the present invention features that the parts of the link seal are not easily disengaged from each other even under the bad conditions where a frictional heat generated by the rotation driving of the bushing or an external force of a high load is applied to the track during the operation of the track, thereby improving durability of the link seal.

To achieve the above objects, the present invention provides a link seal for a track of track-laying vehicle, the link seal including:

an annular main body 200 including a seating groove formed with one or more fine protrusions of an indefinite pattern, a circumferential flange portion 206 formed on the other surface opposed to an adhesive surface of the seating groove in such a fashion as to protrudingly extend outwardly from the outer circumferential surface of a through hole 201, and an annular sleeve 207;

an annular sub-body 100 including a seating part formed with one or more fine protrusions 102 of an indefinite pattern; and

an annular rubber ring 300 made of a cushion material and having a through-hole 301 formed at the center thereof so as to be sized to allow the sleeve 207 of the main body 200 to be fitted thereto so that the sleeve 207 is engaged with the rubber ring 300,

whereby the seating part of the sub-body is correspondingly integrally engaged to the seating groove of the main body, and the sleeve of the main body is fittingly inserted into the through-hole of the rubber ring to allow the main body to be integrally engaged to the rubber ring.

In addition, in the present invention, preferably, one or more fine protrusions may be formed on the seating groove of the main body and the seating part of the sub-body, respectively, in a finely repeated x-shaped indefinite pattern or in a finely repeated mesh-shaped indefinite pattern, and the seating groove and the seating part are roughly surface-treated by a plasma treatment or corona discharge treatment method.

Moreover, in the present invention, preferably, the main body may include one or more first protuberances integrally formed at regular intervals on the seating groove thereof to which the seating part of the sub-body is adhered, and one or more second protuberances integrally formed on the circumferential flange portion thereof abutting against the top surface of the rubber ring. The first and second protuberances are preferably formed in a cylindrical or conical shape.

Also, preferably, the sleeve of the main body may include an outer peripheral surface which is formed in a smooth shape or has a plurality of concavo-convex serrations formed at regular intervals thereon so that the outer peripheral surface of the main body is engaged with the inner peripheral surface of the rubber ring.

### BRIEF DESCRIPTION OF THE DRAWINGS

FIG. 1 is a perspective view illustrating an example of a seal mounted on a track of a tracked vehicle, which is conventionally implemented;

FIG. 2 is a perspective view illustrating an example of an annular reinforcing metal core which is integrally engaged with the inside of an urethane resin body of the seal which is conventionally implemented;

FIG. 3 is an exploded perspective view illustrating the construction of another embodiment of a conventional link seal;

FIG. 4 is an assembled perspective view illustrating the link seal of FIG. 3 which is implemented;

FIG. 5 is an exploded perspective view illustrating the construction of yet another embodiment of a conventional link seal in which a plurality of radially spaced rows of annular protrusion lines is formed on a seating groove of a main body;

FIG. 6 is an exploded perspective view illustrating the construction of still another embodiment of a conventional link seal in which two radially spaced rows of annular fitting recesses are formed on a seating groove of a main body in such a fashion that a pair of opposing fitting recesses of two rows are arranged symmetrically and form an acute angle (θ) therebetween;

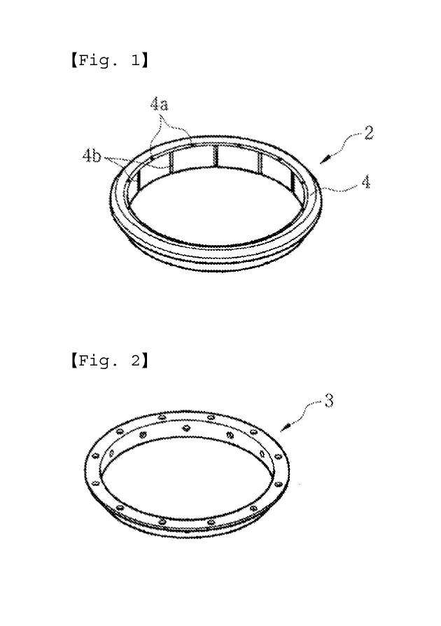

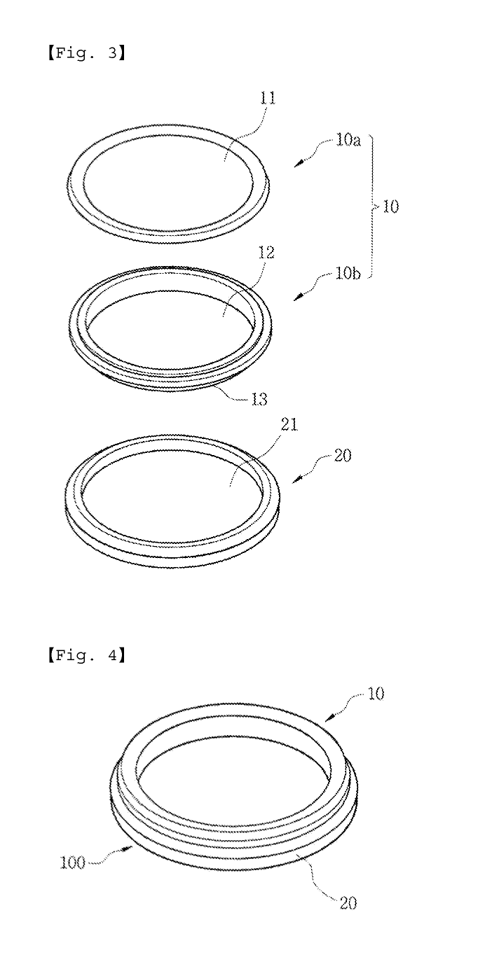

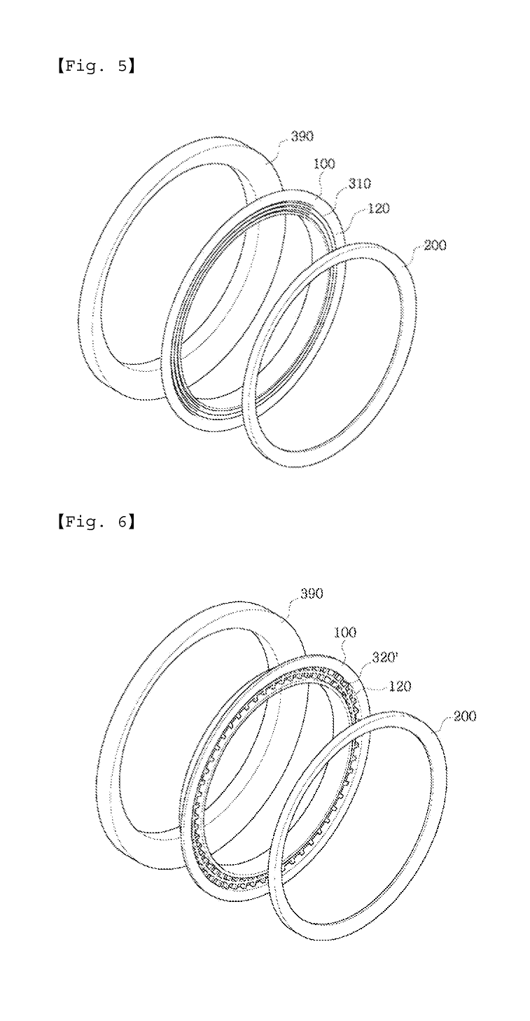

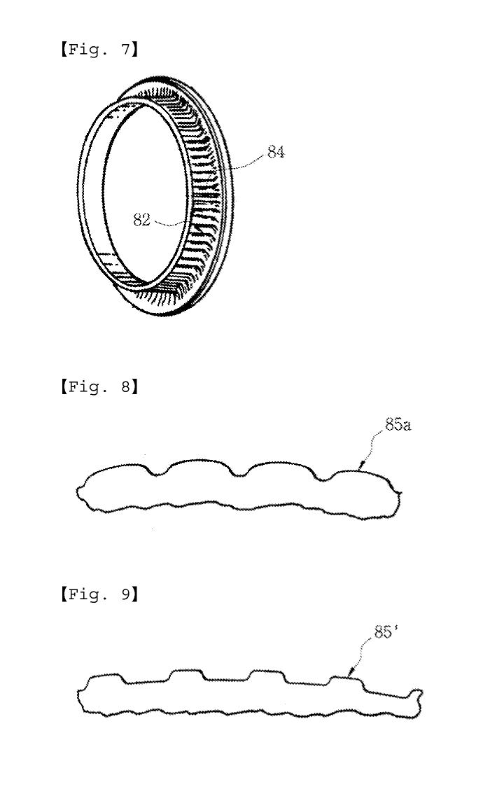

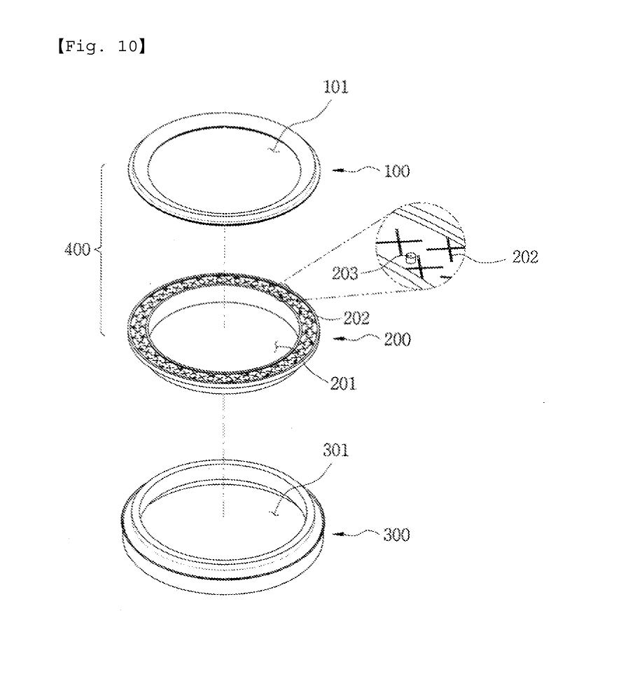

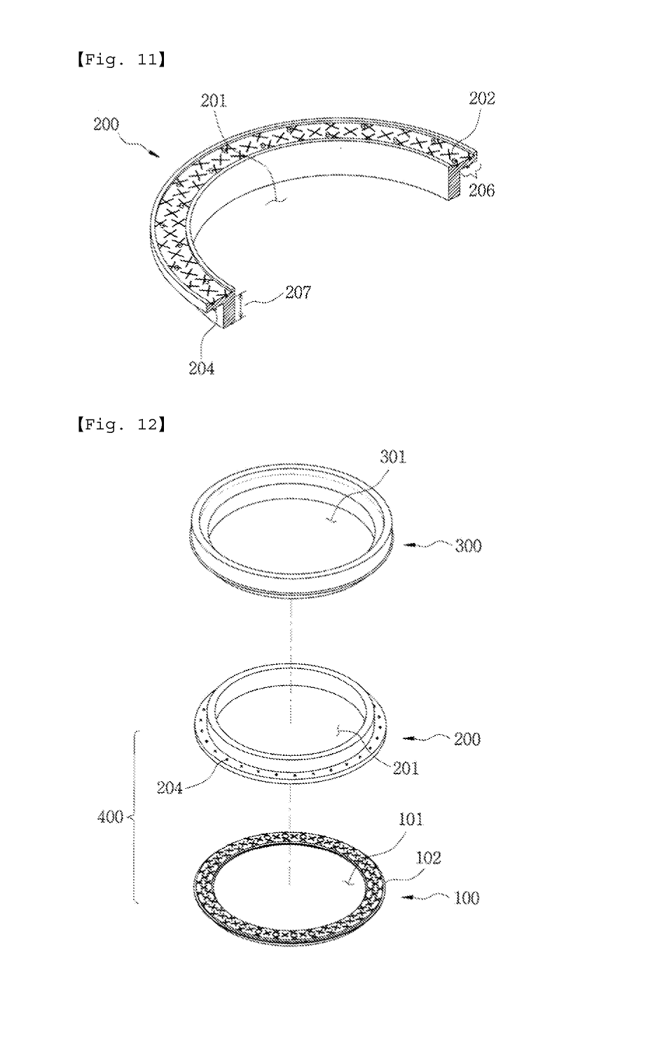

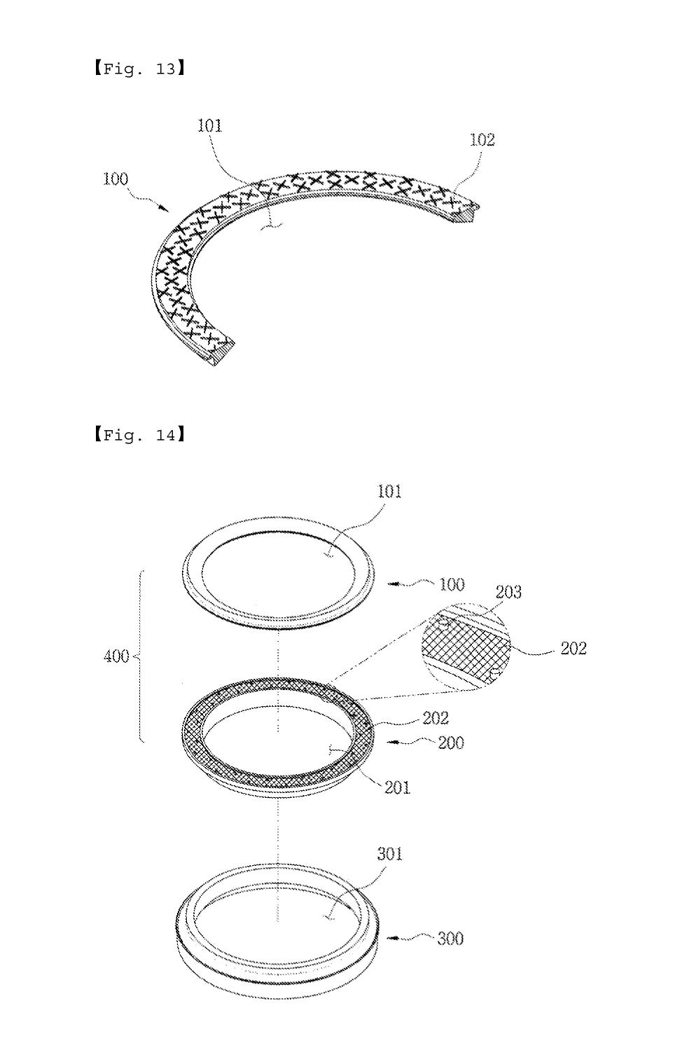

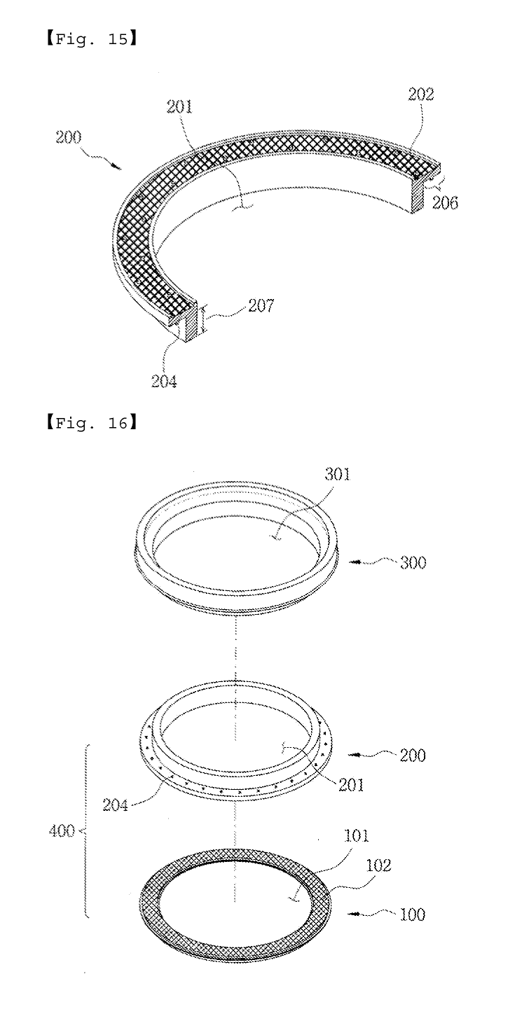

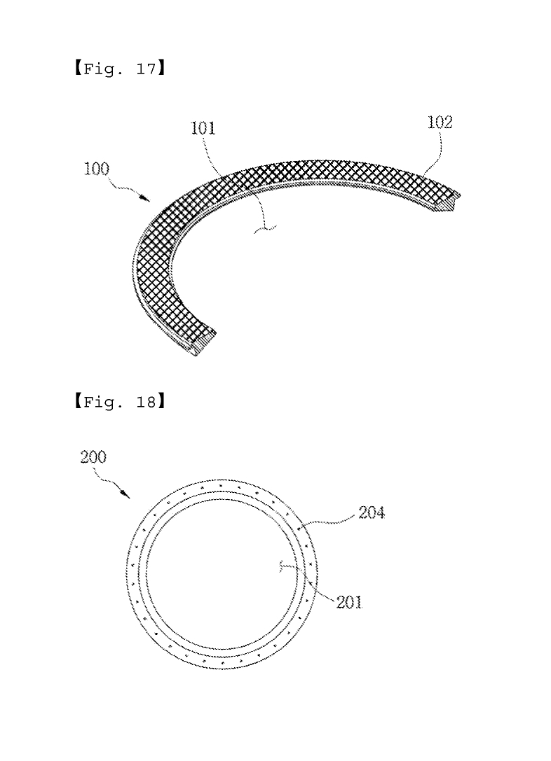

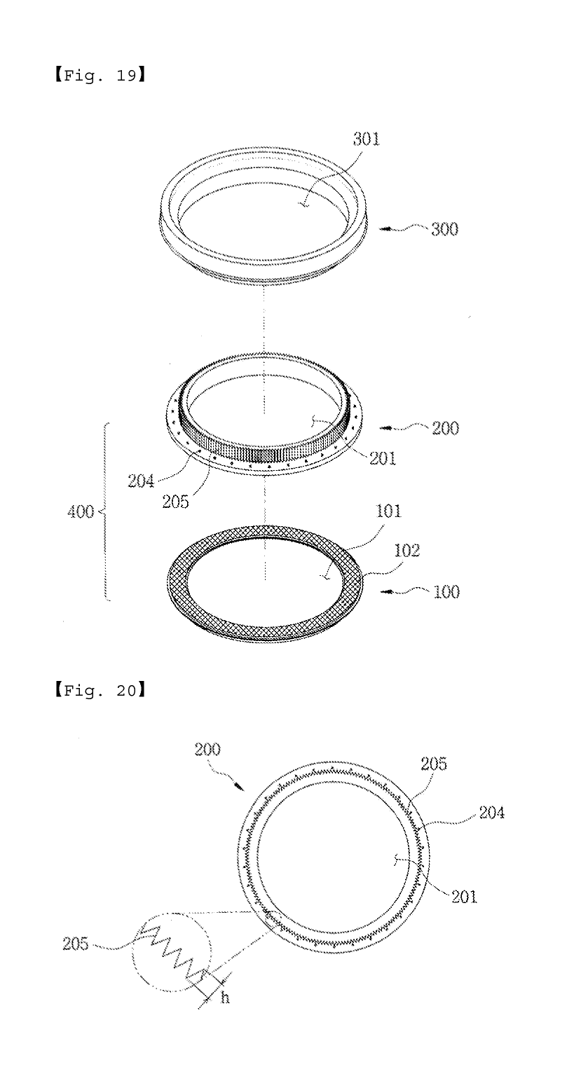

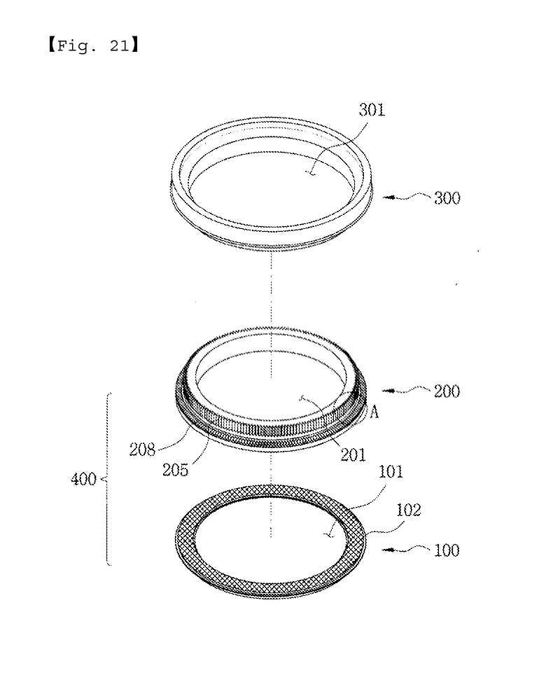

In addition, the present inventor has developed a link seal that includes an annular main body 100 having two radially spaced rows of annular fitting recesses 320′ formed circumferentially on an end surface thereof in such a fashion that a pair of opposing fitting recesses of two rows are arranged symmetrically and form an acute angle (θ) therebetween, an annular sub-body 200 provided on one side of the main body and having two radially spaced rows of annular fitting protrusions formed on a bottom surface thereof to correspond to the fitting recesses 320′ in such a fashion that a pair of opposing fitting protrusions of two rows are arranged symmetrically and form an acute angle therebetween so as to allow the fitting protrusions to be fitted into the fitting recesses 320′ of the main body 100, and a rubber ring 390 as shown in FIG. 6.

FIG. 7 is a perspective view illustrating the construction of a further embodiment of a conventional link seal in which splines of a texture shape are formed on along the outer circumference of a sleeve thereof;

FIG. 8 is a bottom view illustrating a profile of the sleeve of the link seal of FIG. 7, which is formed with splines of a certain shape;

FIG. 9 is a bottom view illustrating a profile of the sleeve of the link seal of FIG. 7, which formed with splines of another shape;

FIG. 10 is an exploded perspective illustrating a link seal in which fine protrusions of an x-shaped indefinite pattern and first protuberances are formed on a seating groove of a main body in accordance with an embodiment of the present invention;

FIG. 11 is a partially enlarged perspective view illustrating the seating groove of the link seal main body of FIG. 10;

FIG. 12 is an exploded perspective illustrating the link seal of FIG. 10, in which second protuberances are formed on a circumferential flange portion of the sleeve of the main body and fine protrusions of an x-shaped indefinite pattern are formed on a seating part of the sub-body;

FIG. 13 is a partially enlarged perspective view illustrating the seating part of the sub-body of FIG. 12;

FIG. 14 is an exploded perspective view illustrating a link seal in which fine protrusions of a mesh-shaped indefinite pattern and first protuberances are formed on a seating groove of a main body in accordance with another embodiment of the present invention;

FIG. 15 is a partially enlarged perspective view illustrating the seating groove of the link seal main body of FIG. 14;

FIG. 16 is an exploded perspective illustrating the link seal of FIG. 10, in which second protuberances are formed on a circumferential flange portion of the sleeve of the main body and fine protrusions of a mesh-shaped indefinite pattern are formed on a seating part of the sub-body;

FIG. 17 is a partially enlarged perspective view illustrating the seating part of the sub-body of FIG. 16;

FIG. 18 is a transverse cross-sectional view illustrating a main body in which a sleeve of the main body is machined smoothly at the outer surface thereof and second protuberances are formed on a circumferential flange portion thereof at regular intervals in accordance with the present invention;

FIG. 19 is an exploded perspective view illustrating a link seal in which a number of serrated concavo-convex patterns are formed on the outer peripheral surface of a sleeve of a main body and second protuberances are formed on a circumferential flange portion thereof at regular intervals in accordance with yet another embodiment of the present invention;

FIG. 20 is a transverse cross-sectional illustrating the main body in which a number of serrated concavo-convex patterns are formed on an outer peripheral surface of the sleeve of the main body and second protuberances are formed on a circumferential flange portion thereof at regular intervals in accordance with yet another embodiment of the present invention;

FIG. 21 is an exploded perspective view illustrating a link seal in which a number of serrated concavo-convex patterns are formed on an outer peripheral surface and a circumferential flange portion of a sleeve of a main body in accordance with still another embodiment of the present invention;

### DETAILED DESCRIPTION OF THE PREFERRED EMBODIMENTS

Now, a preferred embodiment of the present invention will be descried hereinafter in more detail with reference to FIGS. 10 to 21. In FIGS. 10 to 21 and the following description, elements having the same function are denoted by the same reference numerals. In the meantime, in the drawings and the detailed description, illustration and explanation on the construction and operation which can be easily understood by a person skilled in the art from a general link seal for a track of a tracked vehicle will be briefly made or will be omitted to avoid redundancy.

First, the technical idea according to a feature of the present invention will be described hereinafter in detail.

In the present invention, the main body is formed in an annular shape and includes a seating groove formed with one or more fine protrusions of an indefinite pattern, a circumferential flange portion formed on the other surface opposed to an adhesive surface of the seating groove in such a fashion as to protrudingly extend outwardly from the outer circumferential surface of a through hole 201, and an annular sleeve 207 which is engaged with a rubber ring.

The seating groove of the main body and the seating part of the sub-body are constructed to be formed with one or more fine protrusions of an indefinite pattern.

The rubber ring is made of a cushion material and has a through-hole formed at the center thereof so as to be sized to allow the sleeve of the main body to be fitted thereto. The seating part of the sub-body is correspondingly integrally engaged to the seating groove of the main body, and the sleeve of the main body is fittingly inserted into the through-hole of the rubber ring to allow the main body to be integrally engaged to the rubber ring.

In the seal link for a track of a tracked vehicle according to the present invention, it is to be noted that the main body and the sub-body constituting a seal body are integrally adhered to each other, and the seal body and the cushioning rubber ring are integrally engaged with each other.

In addition, the link seal according to the present invention features that the main body made of a high-strength resin is disposed at a portion to which a large pressure is applied and the sub-body made of an urethane resin is disposed at a portion to which a smaller pressure is applied because different pressures are applied to two portions by rotation of a track shaft of the tracked vehicle because different pressures are applied to two portions by rotation of a track shaft of the tracked vehicle such that the different members, i.e., the main body and the sub-body are integrally formed with each other.

The link seal as constructed above enables fine protrusions of an indefinite pattern having various shapes to be primarily formed on the adhesive surfaces of the seating groove of the main body made of a high-strength resin and the seating part of the sub-body and then the adhesive surfaces of the seating groove and the seating part to be treated roughly to increase the adhesion between the main body and sub-body, thereby further improving the cohesion upon the adhesion between the main body and the sub-body.

In addition, the sleeve of annular the main body may include an outer peripheral surface which is formed in a smooth shape or has a plurality of concavo-convex serrations formed at regular intervals thereon so that the outer peripheral surface of the main body is engaged with the inner peripheral surface of the rubber ring.

Moreover, in the case where the sleeve of annular the main body may include an outer peripheral surface which has the concavo-convex serrations formed thereon, the concavo-convex serrations of the main body press the inner peripheral surface of the rubber ring with a certain force so that the outer peripheral surface of the main body sleeve is tightly adhered to the inner peripheral surface of the cushioning rubber ring.

Besides, the link seal as constructed above features that first protuberances and second protuberances of a cylindrical or conical shape are formed at regular intervals on the seating groove of the main body and the circumferential flange portion as the other surface opposite to the seating groove of the main body, respectively, to reinforce the adhesion between the main body and the engagement force between the main body and the cushioning rubber ring, and the first and second protuberances press the adhesive surface of the sub-body and the adhesive surface of the rubber ring so that the main body is engaged with the sub-body and rubber the ring. Thus, parts of the link seal are prevented from being disengaged from each other or damaged even under the bad conditions where a frictional heat generated or an external force of a high load is applied to the track in various work environments as well as in case of the use of the link seal mounted on the track for a long period of time to stably maintain an intrinsic function of the link seal, thereby improving durability of the link seal in the construction and civil engineering industry as well as various work environments.

Now, a preferred embodiment of the present invention will be described hereinafter in detail with reference to the accompanying drawings.

FIG. 10 is an exploded perspective illustrating a link seal in which fine protrusions of an x-shaped indefinite pattern and first protuberances are formed on a seating groove of a main body in accordance with an embodiment of the present invention, FIG. 11 is a partially enlarged perspective view illustrating the seating groove of the link seal main body of FIG. 10, FIG. 12 is an exploded perspective illustrating the link seal of FIG. 10, in which second protuberances are formed on a circumferential flange portion of the sleeve of the main body and fine protrusions of an x-shaped indefinite pattern are formed on a seating part of the sub-body, FIG. 13 is a partially enlarged perspective view illustrating the seating part of the sub-body of FIG. 12, FIG. 14 is an exploded perspective view illustrating a link seal in which fine protrusions of a mesh-shaped indefinite pattern and first protuberances are formed on a seating groove of a main body in accordance with another embodiment of the present invention, FIG. 15 is a partially enlarged perspective view illustrating the seating groove of the link seal main body of FIG. 14, FIG. 16 is an exploded perspective illustrating the link seal of FIG. 10, in which second protuberances are formed on a circumferential flange portion of the sleeve of the main body and fine protrusions of a mesh-shaped indefinite pattern are formed on a seating part of the sub-body, and FIG. 17 is a partially enlarged perspective view illustrating the seating part of the sub-body of FIG. 16.

As shown in FIGS. 10 to 17, a link seal for a track of a tracked vehicle according to the present invention includes: an annular main body 200 including a seating groove formed with a plurality of fine protrusions of an indefinite pattern, a circumferential flange portion 206 formed on the other surface opposed to an adhesive surface of the seating groove in such a fashion as to protrudingly extend outwardly from the outer circumferential surface of a through hole 201, and an annular sleeve 207; an annular sub-body 100 including a seating part formed with a plurality of fine protrusions 102 of an indefinite pattern; and an annular rubber ring 300 made of a cushion material and having a through-hole 301 formed at the center thereof so as to be sized to allow the sleeve 207 of the main body 200 to be fitted thereto so that the sleeve 207 is engaged with the rubber ring 300.

In addition, the link seal for a track of a tracked vehicle according to the present invention is characterized in that the seating part of the sub-body 100 is correspondingly integrally engaged to the seating groove of the main body 200, and the sleeve 207 of the main body 200 is fittingly inserted into the through-hole 301 of the rubber ring 300 to allow the main body to be integrally engaged to the rubber ring.

In other words, the link seal for a track of a tracked vehicle according to the present invention includes a seal body 400 and a rubber ring 300 made of a cushion material as shown in FIG. 10 so that the seal body 400 and the rubber ring 300 are easily engaged with or disengaged from each other. In this case, the elements of the link seal has through-holes 101, 201 and 301 formed at the centers thereof to have a certain size, respectively. In addition, the seating part of the sub-body 100 is integrally engaged to the seating groove of the main body 200, and the sleeve of the main body 200 is fittingly inserted into the through-hole 301 of the cushioning rubber ring 300 to allow the main body to be integrally engaged to the rubber ring.

In the present invention, the seating groove of the main body 200 and the seating part of the sub-body 100 are elements composed of surfaces where the main body 200 and the sub-body 100 are adhered to each other. It is to be noted that the adhesive surfaces of the main body 200 and the sub-body 100 are respectively used mixed with each other.

For reference, FIG. 10 is an exploded perspective illustrating a link seal in which the adhesive surface of the seating groove of the main body is oriented toward the top, and FIG. 12 is an exploded perspective illustrating a link seal in a state in which the drawing of FIG. 10 is inverted, i.e., the adhesive surface of the seating part of the sub-body is oriented toward the top.

The link seal as constructed above according to the present invention has a through-hole formed at the center thereof so that it is easily fitted around a track shaft of a tracked vehicle to perform a function of an O-ring.

To this end, the seal body 400 consisting of the main body 200 and the sub-body 100 is constructed such that the main body and the sub-body have through-holes 101 and 201 formed at the centers thereof to have a certain size, respectively.

In addition, the cushion rubber ring 300 is formed of a synthetic rubber having an excellent elasticity so that it is integrally engaged with the seal body 400 consisting of the main body 200 and the sub-body 100. Also, the rubber ring 300 has a through-hole 301 formed at the center thereof to have a given size such that the inner diameter of the through-hole 301 is larger than the outer diameter of the sleeve 207 formed on the main body 200.

That is, the sleeve 207 of the main body 200 is fittingly engaged to the through-hole 301 of the cushioning rubber ring 300 while the outer peripheral surface of the sleeve is brought into close contact with the inner peripheral surface of the through-hole 301. Since the sleeve is not coated with a separate adhesive, it can be easily engaged with or disengaged from the rubber ring 300.

Thus, once the link seal having the seal body 400 and the cushioning rubber ring 300 which are engaged with each other is mounted on a track of a tracked vehicle, it is not separated from the track.

In the present invention, the seal body 400 consisting of the main body 200 and the sub-body 100 is constructed such that a number of fine protrusions 102 and 202 of an indefinite pattern are formed on the adhesive surfaces of the seating groove of the main body 200 and the seating part of the sub-body 100 to enhance the adhesion between the main body 200 and the sub-body 100.

The fine protrusions 102 and 202 are formed on the adhesive surfaces of the main body 200 and the sub-body 100, i.e., the surfaces of the seating groove of the main body 200 and the seating part of the sub-body 100, respectively, in a finely repeated x-shaped indefinite pattern as shown in FIGS. 10 to 13. Alternatively, the fine protrusions 102 and 202 are formed on the adhesive surfaces of the main body 200 and the sub-body 100, respectively, in a finely repeated mesh-shaped indefinite pattern as shown in FIGS. 14 to 17 to maximally increase the adhesive area between the main body 200 ad the sub-body 100, thereby to further the adhesion between the main body 200 and the sub-body 100.

In the present invention, the fine protrusions 102 and 202 may formed in various fine patterns of other shapes besides the finely repeated x-shaped indefinite pattern or the finely repeated mesh-shaped indefinite pattern.

In addition, the adhesive surfaces of the main body 200 and the sub-body 100, i.e., a top surface of the main body 200 and a bottom surface of the sub-body 100 are preferably surface-treated to improve the adhesion between the main body 200 and the sub-body 100 such that the adhesive surfaces are treated roughly.

In the present invention, the surface-treatment of the seating groove of the main body 200 and the seating part of the sub-body 100 is performed by a traditional plasma treatment or corona discharge treatment method such as a plastic surface treating technique such that the adhesive surfaces are treated roughly to maximize the cohesion between the surfaces of the main body and the sub-body.

In the present invention, as the surface treatment method for the adhesive surfaces of the main body 200 and the sub-body 100, all the surface treatment methods having the equivalent effect to that of the above-mentioned surface treatment method may be adopted besides the limited plasma treatment or corona discharge treatment method.

In addition, in the present invention, a material used for forming the main body 200 is preferably a high-strength resin. The high-strength resin is preferably formed by any one selected from materials such as polycarbonate, MC nylon, and the like, or a mixture thereof. A material used for forming the sub-body 100 is preferably a polyurethane resin, and a material for the cushioning rubber ring 300 is preferably a synthetic resin.

Further, in the present invention, the main body 200 includes numerous cylindrical or conical shaped first protuberances 203 integrally formed on the adhesive surface thereof at regular intervals to increase the adhesion between the main body 200 and the sub-body 100 as shown in FIGS. 10 and 12.

The first protuberances 203 as constructed above is adhered to the adhesive surface of the sub-body 100 in a state of being pressed by the adhesive surface of the sub-body 100, so that the cohesion between the two members can be maximized. In addition, the first protuberance of a cylindrical or conical shape serves as a support which supports the sub-body (sealing part), so that the main body 200 and the sub-body 100 are not easily disengaged from each other or damaged and can stably maintain an intrinsic function of the link seal even under the external bad conditions such as a high load, a rotation frictional force, etc., by the rotation driving of the tracked vehicle having a caterpillar.

In addition, in the present invention, the first protuberances 203 may be formed in various shapes besides the limited cylindrical or conical shape.

In this case, the sleeve 207 of the main body 200 preferably includes an outer peripheral surface which is formed in a smooth shape as shown in FIG. 18 or has a plurality of concavo-convex serrations 205 formed at regular intervals thereon as shown in FIGS. 19 and 20 so that the outer peripheral surface of the main body is engaged with the inner peripheral surface of the rubber ring.

FIG. 18 is a transverse cross-sectional view illustrating a main body in which a sleeve of the main body is machined smoothly at the outer surface thereof and second protuberances are formed on a circumferential flange portion thereof at regular intervals in accordance with the present invention, FIG. 19 is an exploded perspective view illustrating a link seal in which a number of serrated concavo-convex patterns are formed on the outer peripheral surface of a sleeve of a main body and second protuberances are formed on a circumferential flange portion thereof at regular intervals in accordance with yet another embodiment of the present invention, and FIG. 20 is a transverse cross-sectional illustrating the main body in which a number of serrated concavo-convex patterns are formed on an outer peripheral surface of the sleeve of the main body and second protuberances are formed on a circumferential flange portion thereof at regular intervals in accordance with yet another embodiment of the present invention.

The shape of the concavo-convex patterns 205 basically takes a serrated shape as shown in FIGS. 19 and 20, but may be formed in various shapes besides the serrated shape. The height “h” (i.e., distance between a crest and a valley) of the concavo-convex serrations formed on the outer peripheral surface of the sleeve 207 and a pitch between two adjoining crests or valleys are particularly limited.

In addition, the circumferential flange portion 206 of the main body 200 preferably includes numerous cylindrical or conical shaped second protuberances 204 integrally formed at regular intervals on the other surface opposite to the adhesive surface of the seating groove. The second protuberances 204 may be formed in various shapes besides the limited cylindrical or conical shape.

Thus, the main body 200 allows the plurality of concavo-convex serrations 205 formed at regular intervals on the outer peripheral surface of the sleeve to press the inner peripheral surface of the cushioning rubber ring 300 to primarily produce a close adhesion effect in which the main body 200 is engaged with the rubber ring 300 in such a fashion as to be closely adhered to the rubber ring 300. Also, the main body 200 allows the second protuberances 204 formed on the circumferential flange portion 206 to securely press the top surface of the cushioning rubber ring 300 with more than a certain force to secondarily produce a compulsive locking function between the main body and the cushioning rubber ring. Therefore, a slip phenomenon of the rubber ring is completely prevented so that the main body and the cushioning rubber ring are not easily disengaged from each other or damaged and can maintains an intrinsic function of the link seal even under the worst conditions.

Besides, as shown in FIG. 21 numerous serrated concavo-convex patterns 205 are formed on the outer peripheral surface of the sleeve of the main body 200, and numerous serrated concavo-convex patterns 208 are formed on the circumferential flange portion of the main body 200 to further reinforce the adhesion between the main body and the cushioning rubber ring.

FIG. 21 is an exploded perspective view illustrating a link seal in which a number of serrated concavo-convex patterns are formed on an outer peripheral surface and a circumferential flange portion of a sleeve of a main body in accordance with still another embodiment of the present invention.

According to the link seal as constructed above, the fine protrusions 102 and 202 of an indefinite pattern are formed on the adhesive surfaces of the main body made of a high-strength resin and the sub-body and then the adhesive surfaces are treated roughly to increase the adhesion between the two members. In addition, the first protuberances 203 and the second protuberances 204 of a cylindrical shape are formed on the seating groove and the circumferential flange portion 206 of the main body 200 at regular intervals, respectively. Alternatively, the concavo-convex serrations 205 and 208 are formed on the outer peripheral surface and the circumferential flange portion of the main body 200, respectively, to prevent the respective elements of the link seal from being disengaged from each other, or preventing the slip or spin phenomenon from occurring, so that a link seal assembly capable of maintaining an excellent performance can be provided even under the bad conditions where a frictional heat generated by the rotation driving of the bushing or an external force of a high load is applied to the track during the operation of the track as well as in case of the use of the link seal for a long period of time.

As described above, the present invention has the following effects.

The fine protrusions of an indefinite pattern having various shapes are formed on the seating groove of the main body and the seating part of the sub-body and then the adhesive surfaces of the seating groove and the seating part are treated roughly to increase the cohesion between the two members. In addition, the first protuberances 203 formed at regular intervals on the seating groove of the main body press the adhesive surface of the sub-body when the main body and the sub-body are integrally engaged with each other to function as a support between two different members, thereby further improving the cohesion between the main body and the sub-body so that the sub-body is prevented from being disengaged from the main body even under the bad conditions, and enhancing a traction force of the link seal

Moreover, a plurality of concavo-convexes of various shapes are formed on the outer peripheral surface of the sleeve extending from the bottom surface of the annular main body to primarily press the inner peripheral surface of the rubber ring, and a plurality of conical shaped protuberances is circumferentially formed at regular intervals on the circumferential flange portion of the sleeve, which is perpendicular to the outer peripheral surface of the sleeve and abuts against the rubber ring so that the conical shaped protuberances securely press the top surface of the cushioning rubber ring with more than a certain force to secondarily produce a compulsive (physical) locking function between the main body and the cushioning rubber ring. Therefore, a slip phenomenon of the rubber ring can be completely prevented so that the main body and the cushioning rubber ring are not easily disengaged from each other and can maintains an intrinsic function of the link seal even under the worst conditions, and the endurance lifespan f the expensive equipment can be prolonged.

Thus, the present invention can reinforce the adhesion and the engagement force between respective parts of the link seal so as to smoothly maintain a sealing function of the link seal assembly consisting of the main body, the sub-body, and the cushioning rubber ring so that the parts of the link seal are not easily disengaged from each other even under the bad conditions where a frictional heat generated by the rotation driving of the bushing or an external force of a high load is applied to the track during the operation of the track as well as in case of the use of the link seal for a long period of time, thereby improving durability of the link seal.

While the link seal for a track of a tracked vehicle according to the preferred embodiments of the present invention has been described and illustrated in connection with specific exemplary embodiments with reference to the accompanying drawings, it will be readily appreciated by those skilled in the art that it is merely illustrative of the preferred embodiments of the present invention and various modifications and changes can be made thereto within the technical spirit and scope of the present invention.

What is claimed is:

1. A link seal for a track of track-laying vehicle, the link seal comprising:
an annular main body 200 including a seating groove formed with one or more fine protrusions of an indefinite pattern, a circumferential flange portion 206 formed on the other surface opposed to an adhesive surface of the seating groove in such a fashion as to protrudingly extend outwardly from the outer circumferential surface of a through hole 201, and an annular sleeve 207;
an annular sub-body 100 including a seating part formed with one or more fine protrusions 102 of an indefinite pattern; and
an annular rubber ring 300 made of a cushion material and having a through-hole 301 formed at the center thereof so as to be sized to allow the sleeve 207 of the main body 200 to be fitted thereto so that the sleeve 207 is engaged with the rubber ring 300,
whereby the seating part of the sub-body is correspondingly integrally engaged to the seating groove of the main body, and the sleeve of the main body is fittingly inserted into the through-hole of the rubber ring to allow the main body to be integrally engaged to the rubber ring.

2. The link seal according to claim 1, wherein one or more fine protrusions are formed on the seating groove of the main body and the seating part of the sub-body, respectively, in a finely repeated x-shaped indefinite pattern or in a finely repeated mesh-shaped indefinite pattern.

3. The link seal according to claim 2, wherein the seating groove of the main body and the seating part of the sub-body are roughly surface-treated by a surface blasting method by corrosion, or a plasma treatment or corona discharge treatment method.

4. The link seal according to claim 3, wherein the main body includes one or more first protuberances integrally formed at regular intervals on the seating groove thereof to which the seating part of the sub-body is adhered.

5. The link seal according to claim 2, wherein the main body includes one or more first protuberances integrally formed at regular intervals on the seating groove thereof to which the seating part of the sub-body is adhered.

6. The link seal according to claim 1, wherein the main body includes one or more first protuberances integrally formed at regular intervals on the seating groove thereof to which the seating part of the sub-body is adhered.

7. The link seal according to claim 3, wherein the main body includes one or more second protuberances integrally formed on the circumferential flange portion thereof abutting against the top surface of the rubber ring.

8. The link seal according to claim 2, wherein the main body includes one or more second protuberances integrally formed on the circumferential flange portion thereof abutting against the top surface of the rubber ring.

9. The link seal according to claim 1, wherein the main body includes one or more second protuberances integrally formed on the circumferential flange portion thereof abutting against the top surface of the rubber ring.

10. The link seal according to claim 3, wherein the sleeve of the main body includes an outer peripheral surface which is formed in a smooth shape or has a plurality of concavo-convex serrations formed at regular intervals thereon so that the outer peripheral surface of the main body is engaged with the inner peripheral surface of the rubber ring.

11. The link seal according to claim 2, wherein the sleeve of the main body includes an outer peripheral surface which is formed in a smooth shape or has a plurality of concavo-convex serrations formed at regular intervals thereon so that the outer peripheral surface of the main body is engaged with the inner peripheral surface of the rubber ring.

12. The link seal according to claim 1, wherein the sleeve of the main body includes an outer peripheral surface which is formed in a smooth shape or has a plurality of concavo-convex serrations formed at regular intervals thereon so that the outer peripheral surface of the main body is engaged with the inner peripheral surface of the rubber ring.

13. The link seal according to claim 6, wherein the first protuberances are formed in a cylindrical or conical shape.

14. The link seal according to claim 5, wherein the first protuberances are formed in a cylindrical or conical shape.

15. The link seal according to claim 4, wherein the first protuberances are formed in a cylindrical or conical shape.

16. The link seal according to claim 9, wherein the second protuberances are formed in a cylindrical or conical shape.

17. The link seal according to claim 8, wherein the second protuberances are formed in a cylindrical or conical shape.

18. The link seal according to claim 7, wherein the second protuberances are formed in a cylindrical or conical shape.

19. The link seal according to claim 9, wherein the main body includes has a plurality of concavo-convex serrations formed on the circumferential flange portion thereof abutting against the top surface of the rubber ring.

20. The link seal according to claim 8, wherein the main body includes has a plurality of concavo-convex serrations formed on the circumferential flange portion thereof abutting against the top surface of the rubber ring.

21. The link seal according to claim 7, wherein the main body includes has a plurality of concavo-convex serrations formed on the circumferential flange portion thereof abutting against the top surface of the rubber ring.
